(19) United States
(12) Patent Application Publication
(10) Pub. No.: US 2011/0072309 A1
(43) Pub. Date: Mar. 24, 2011

(54) Debugger for Multicore System

(76) Inventors: Ryuji Sakai, Hanno-shi (JP); Motohiro Takayama, Tachikawa-shi (JP)

(21) Appl. No.: 12/877,707

(22) Filed: Sep. 8, 2010

(30) Foreign Application Priority Data
Sep. 24, 2009 (JP) 2009-218565

(51) Int. Cl. G06F 11/36

(52) U.S. Cl. 714/35; 714/E11.21; 714/E11.217

(57) ABSTRACT

A debugger includes: a plurality of processor cores; and a scheduler configured to control an allocation of a plurality of basic modules to the processor cores based on an execution rule for enabling parallel execution of a program that is divided into the basic modules that are executable asynchronously with one another, the program being defined with the execution rule of the basic modules for executing the basic modules in time series, wherein the scheduler includes a break point setting module configured to set a group of break points that are designated through a graphical user interface.

### CROSS-REFERENCE TO THE RELATED APPLICATION(S)

The present application is based upon and claims priority from prior Japanese Patent Application No. 2009-218565, filed on Sep. 24, 2009, the entire contents of which are incorporated herein by reference.

### BACKGROUND

1. Field

The present invention relates to a debugging tool for a parallel program.

2. Description of the Related Art

In recent years, a multi-task OS (Operating System) has been used in order to improve process efficiency in a microcomputer. In the following description, a term “task” is used to describe one processor core processed by a control program of the OS, and a term “multi-task environment” is used to describe an environment in which a plurality of tasks required to perform a plurality of applications in parallel can be processed in parallel.

It is required to repeatedly verify and check the operation of the application software that is executed in the multi-task environment until the application software satisfies predetermined operation specifications and predetermined function specifications. A debugger is a tool for analyzing and correcting defects when the application software does not satisfy the operation conditions and the specifications. That is, the debugger is a program that loads a program to be debugged onto a computer and executes basic operations, such as execution, stop, an operation of referring to variables and content, and an operation of changing the variables and content. The debugging operations are also applied to parallel processing executed by a multi-processor.

In general, the debugger is used as follows. That is, after the debugger starts, a program to be debugged is executed. In this case, a stop point, which is called a break point, is set to a specific address in the program in advance. When the program reaches the break point, the execution of the program stops such that the user can control the program. The value of a predetermined variable on the memory is checked or the content of a register is checked at the break point. Therefore, it is possible to check the operations, analyze defects, and correct program codes based on the check result. The break point function is the most basic function of the debugger. The setting and cancellation of the break point are inevitable in the debugging operation.

In order to debug the multi-task environment, it is necessary to individually check the execution of each task. Therefore, the following conditions are required for the debugger. That is, since a plurality of tasks is executed at the same time, it is necessary to individually debug each task. That is, it is necessary to set an individual breakpoint to each task.

However, in the related art, in the case in which the break point is set to a parallel program executed by multiple threads on the debugger and then the program is executed, when one thread stops at the break point, the other threads also stop at the same time. When the execution of the program is resumed, all the threads are resumed. Therefore, the related art does not disclose a unit that interrupts the execution of a plurality of threads at a specific breakpoint at the same time. In addition, the related art does not disclose a unit that effectively sets a plurality of break points. Further, the related art does not disclose a unit that continuously executes only a specific task while stopping threads other than a target thread among a plurality of threads and examines the details of an operation.

A publication JP-A-2009-064233 discloses a technique having a configuration that interrupts the execution of a plurality of threads at a specific break point at the same time. However, JP-A-2009-064233 does not disclose a general-purpose technique capable of solving all of the above-mentioned problems.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a diagram illustrating an example of the system structure of an information processing apparatus according to an embodiment of the invention.

FIG. 2 is a diagram illustrating the schematic structure of a program with parallel processing specifications executed by the information processing apparatus according to the embodiment.

FIG. 3 is a diagram illustrating the relationship between sequential basic modules and a parallel execution control description of the program executed by the information processing apparatus according to the embodiment.

FIG. 4 is a diagram schematically illustrating a parallel program execution environment according to the invention.

FIGS. 5A and 5B are diagrams illustrating the parallel execution control description of the program executed by the information processing apparatus according to the embodiment.

FIG. 6 is a diagram illustrating the parallel processing control of the program executed by a runtime library that is operated on the information processing apparatus according to the embodiment.

FIG. 7 is a diagram illustrating the operation state of the runtime library on the information processing apparatus according to the embodiment.

FIG. 8 is a diagram illustrating the operation state of the runtime library and the basic module on the information processing apparatus according to the embodiment.

FIG. 9 is a diagram illustrating an example of a screen of a visual debugger according to the invention.

FIG. 10 is a diagram illustrating tasks stopped at break points according to the invention.

FIG. 11 is a diagram illustrating the start of the execution of tasks at the same time in the embodiment.

FIG. 12 is a diagram illustrating the start of the execution of only a selected module in the embodiment.

FIG. 13 is a diagram illustrating the relationship between a GUI tool, a debugger, a parallel execution environment, and an application according to the embodiment.

FIG. 14 is a flowchart illustrating the details of a parallel operation at a plurality of break points in an execution environment.

FIG. 15 is a diagram illustrating a method of managing a plurality of break points.

FIG. 16 is a diagram illustrating a function of supporting the designation of a parallel break point.

FIG. 17 is a diagram illustrating a general multi-thread process.

### DETAILED DESCRIPTION

An embodiment according to the present invention will be described in detail with reference to the accompanying drawings. The scope of the claimed invention should not be limited to the examples illustrated in the drawings and those described below.

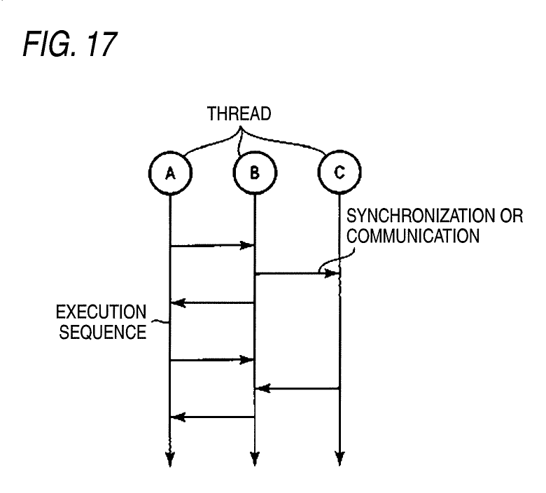

FIG. 17 shows a general programming model according to the related art. In the thread execution type according to the related art, a synchronization process is incorporated into the program of each module that is executed as a thread to acquire data between the threads or perform exclusive control, thereby performing a cooperative operation. However, this embodiment includes basic modules that are executed sequentially without synchronization and a parallel operation defining unit that defines a parallel operation, which will be described below. The parallel operation defining unit executes synchronization or receives data. In this way, it is possible to facilitate the modularization of the basic module and reduce the size of the parallel operation defining unit.

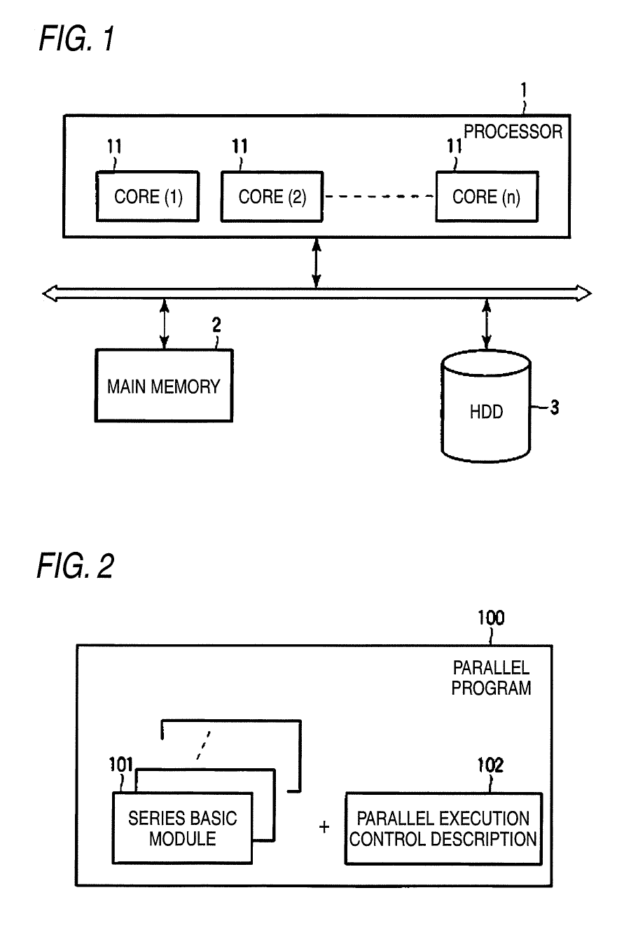

FIG. 1 is a diagram illustrating an example of the system structure of an information processing apparatus according to an embodiment of the invention. The information processing apparatus is a so-called personal computer, such as a notebook computer or a desktop computer. As shown in FIG. 1, the computer includes a processor 1, a main memory 2, and a hard disk drive (HDD) 3 which are connected to each other by an internal bus. An apparatus to which developed parallel software is applied is not limited to a PC, but the parallel software may be applied to other apparatuses, such as a digital TV, a DVR, and a mobile phone.

The processor 1 is a central processor core (CPU) that controls the execution of a program that is loaded from the HDD 3, which is a storage medium that can be accessed by the information processing apparatus, such as a computer, to a main memory, and includes a plurality of cores 11, which are main arithmetic circuits (CPU cores). In the embodiment, the core 11 serves as a processor core.

The main memory 2 is a storage device, such as a semiconductor memory device that can be accessed by the processor 1. The HDD 3 is a low-speed and high-capacity storage medium (as compared to the main memory 2) which serves as an auxiliary memory device of the computer.

Although not shown in the drawings, when the computer is a notebook computer, the computer further includes input/output devices, such as a display for displaying the process result of the program by the processor 1 and a keyboard for inputting processed data. When the computer is a desktop computer, the computer is connected to an external apparatus by, for example, a cable.

The computer including the processor 1 provided with a plurality of cores 11 can perform a plurality of programs in parallel, and also perform a plurality of processes in one program in parallel. Next, the schematic structure of a program with parallel processing specifications that is executed by the computer will be described with reference to FIG. 2.

As shown in FIG. 2, an execution program 100 with parallel processing specifications that is executed by the computer includes a plurality of sequential basic modules 101 and a parallel execution control description 102 that defines the order in which the plurality of sequential basic modules 101 is executed.

As shown in FIG. 17, in general, in a so-called multi-thread process, each thread executes a process while synchronizing other threads (including communication), that is, while ensuring consistence between all the programs. Therefore, when synchronization occurs in many places, it is considered that it is difficult to obtain an expected parallel performance.

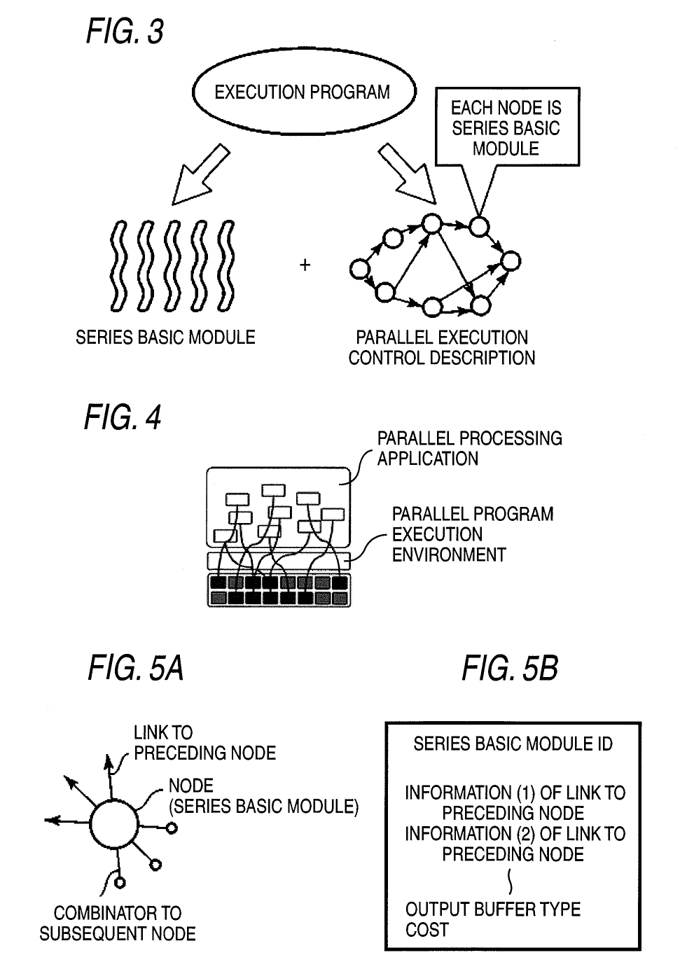

In this embodiment, as shown in FIG. 3, the program is divided into process units that can be asynchronously executed, without any synchronization with other modules, thereby creating the plurality of sequential basic modules 101 and the parallel execution control description 102 that defines the dependencies of the sequential basic modules 101. In parallel execution control, each of the sequential basic modules 101 is represented as a node. The term “sequential basic modules” is used to describe a unit module that can be executed in the partial order of other modules represented by a parallel description. Nodes having no difference in the partial order (sequential basic modules having no dependency with one another) are asynchronously executed in parallel.

FIG. 4 shows the execution environment of the parallel program according to the invention. A complier converts the parallel execution control description into a data structure (or a byte code) that is used by the execution environment. The execution environment dynamically generates a graph structure (task graph) having the basic module (task) as a node and data dependency as a side, based on the data structure. The execution environment allocates a task to the processor and executes parallel processing according to a partial order relation indicated by the task graph. In the example shown in FIG. 4, the processor includes 16 cores 11.

Next, the parallel execution control description 102 will be described with reference to FIGS. 5A and 5B.

FIG. 5A is a conceptual diagram illustrating a node indicating a given sequential basic module 101. As shown in FIG. 5A, each sequential basic module 101 is regarded as a node including a link to the preceding node and a connector to the subsequent node. The parallel execution control description 102 describes information of a link to the preceding node in each sequential basic module 101 to define the order in which a plurality of sequential basic modules 101 is executed. FIG. 5B is a diagram illustrating an example of a parallel execution control description related to a given sequential basic module 101. As shown in FIG. 5B, the parallel execution control description includes a sequential basic module ID, which is an identifier, and information of a link to the preceding node of the sequential basic module 101. In addition, the parallel execution control description includes information of the type of output buffer and the size of generated data.

Next, the execution of the parallel program 100 including the plurality of sequential basic modules 101 and the parallel execution control description 102 by the computer will be described.

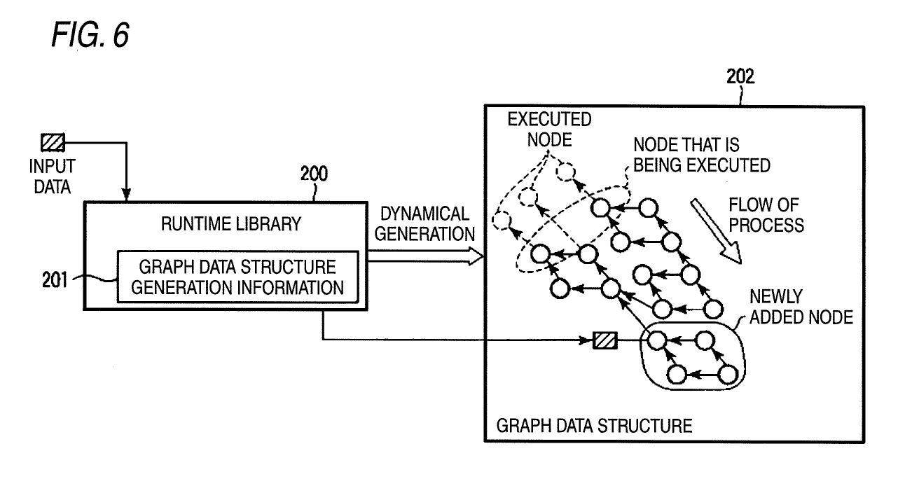

In order to perform parallel processing on the execution program 100 having the above-mentioned structure, for example, a runtime library 200 shown in FIG. 6 is used as the execution environment of a runtime process in the computer. The runtime library 200 is stored in the HDD 3, which is a storage medium that can be accessed by a computer information processing apparatus. The runtime library 200 loaded from the hard disk drive 3 to the main memory is executed by the processor 1. The runtime library 200 functions as a scheduler and includes the parallel execution control description 102 given as graph data structure generation information 201. The parallel execution control description 102 is created by, for example, a functional language and is translated into the graph data structure generation information 201 by a translator.

When data is input, it is necessary to perform some sequential basic modules 101 in order to process the input data. The runtime library 200 dynamically generates and updates a graph data structure 202 indicated by an edge connecting a plurality of nodes based on the graph data structure generation information 201 whenever the sequential basic modules are executed. The graph data structure 202 is graph data indicating the dependencies between node groups that are appropriately executed. The runtime library 200 adds the node groups to the graph data structure 202 in consideration of both the dependencies between the nodes to be added and the dependencies between the nodes that are standing by ready to be executed.

When an execution of a given node is finished, the runtime library 200 deletes the node from the graph data structure 202. Then, the runtime library 200 checks subsequent node that is subsequent to the finished node, and search for a node having all the preceding nodes being executed. When such node is found, the node having all the preceding nodes being executed is allocated to any one of the cores 11.

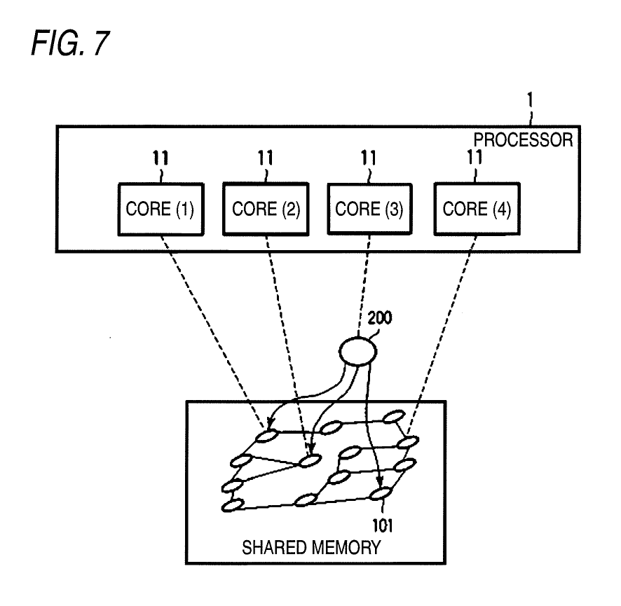

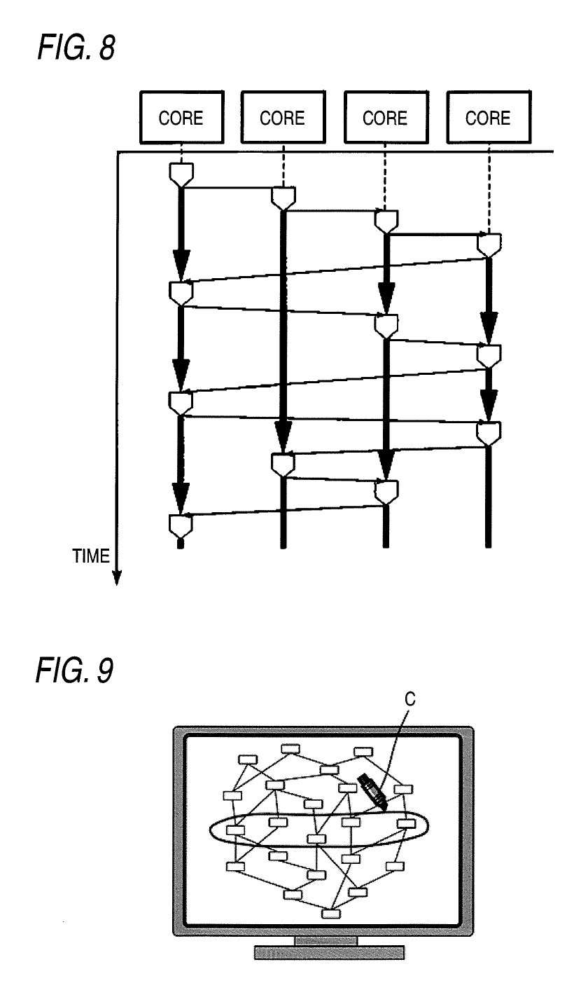

A plurality of sequential basic modules 101 is executed in parallel by the function of the runtime library 200 based on the parallel execution control description 102, with consistency. In addition, the runtime library 200 is executed by threads (multiple threads) whose number is greater than the number of cores 11 provided in the processor 1. As a result, as shown in FIGS. 7 and 8, it is possible to operate the computer such that each core 11 (the runtime library 200, which is one thread under an OS 300 of each core 11) autonomously finds the next sequential basic module 101 to be executed. Exclusive control between the threads includes only the selection of the node from the graph data structure 202 by the runtime library 200 and the update of the graph data structure. Therefore, it is possible to achieve a high parallel performance, as compared with a general multi-thread process shown in FIG. 17.

FIGS. 7 and 8 are diagrams illustrating the sequence of a parallel operation of the basic modules in a parallel execution environment. When a given core completely executes a task and calls an execution environment, the execution environment updates a task graph by the completion of the execution of the task and adds an executable task to an executable queue. When the task has already been registered to the executable queue, the core extracts one task from the executable queue and then starts to perform the task. Then, the next core calls an execution environment and selects an executable task. When there is no executable task, the core executes a process of registering a new task to the task graph until an executable task is found, based on the data structure generated by the definition of the parallel operation. When no executable task is found until a resource, such as a memory size, reaches a limit, the core waits for the completion of the preceding program.

FIG. 7 shows four cores 11. In FIG. 7, among the four cores, a core (2) 11 executes the runtime library 200, and the runtime library 200 calls one basic module from the plurality of sequential basic modules 101.

In FIG. 8, a pentagon indicates the runtime library 200 and a bold arrow indicates the basic module. The length of the bold arrow indicates the execution time of the basic module.

As shown in FIG. 8, the process time of the execution environment is sufficiently shorter than the execution time of a task. Therefore, even when the execution environment is continuously executed between the cores, it is possible to obtain sufficient parallelism. When the hierarchical structure of the program is used, it is possible to perform the execution environment in parallel.

A plurality of sequential basic modules 101 is executed in parallel by the function of the runtime library 200 based on the parallel execution control description 102, without any inconsistency. In addition, the runtime library 200 is executed by threads (multiple threads) whose number is greater than the number of cores 11 provided in the processor 1. As a result, as shown in FIGS. 7 and 8, it is possible to operate the computer such that each core 11 (the runtime library 200, which is one thread under the OS 300 of each core 11) autonomously finds the next sequential basic module 101 to be executed. Exclusive control between the threads includes only the selection of the node from the graph data structure 202 by the runtime library 200 and the update of the graph data structure. Therefore, it is possible to achieve a high parallel performance, as compared with the general multi-thread process shown in FIG. 17.

FIG. 9 is a diagram illustrating a screen of the debugging tool for the parallel program according to the invention. The task graph that will be actually executed from the upper side to the lower side in chronological order is displayed on the debug screen. The invention is characterizes in that a pointer device C is operated to draw a line surrounding a plurality of break points, thereby simultaneously setting the break points (designate a group of break points). When the break points are set, a GUI (Graphical User Interface) tool receives the action of the user and stores information of the break points.

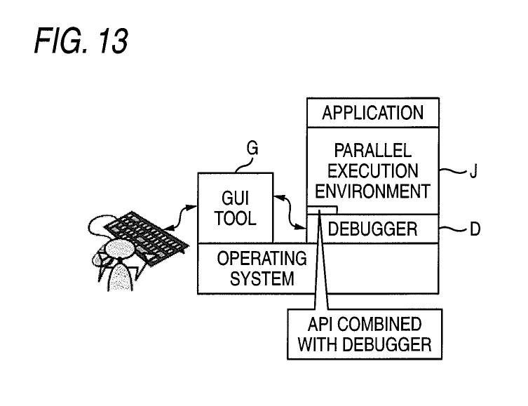

FIG. 13 is a diagram illustrating the relationship between the GUI tool, the debugger, the parallel execution environment, and an application. When a GUI tool G starts to perform the parallel execution environment on a debugger D, a break command is executed at the entry of the parallel execution environment J to interrupt the execution of the program. The GUI tool G uses the command of the debugger D to call an API of the parallel execution environment J and transmits the set break point information to the parallel execution environment J. The parallel execution environment J stores the received breakpoint information.

The GUI tool G, the debugger D, the parallel execution environment J, the operating system, and the application may be provided as a computer readable program, and the computer readable program may be provided in a form contained in a computer readable medium of any type, such as a USB storage device, an external hard disk drive, or the main memory 2 and HDD 3 as shown in FIG. 1.

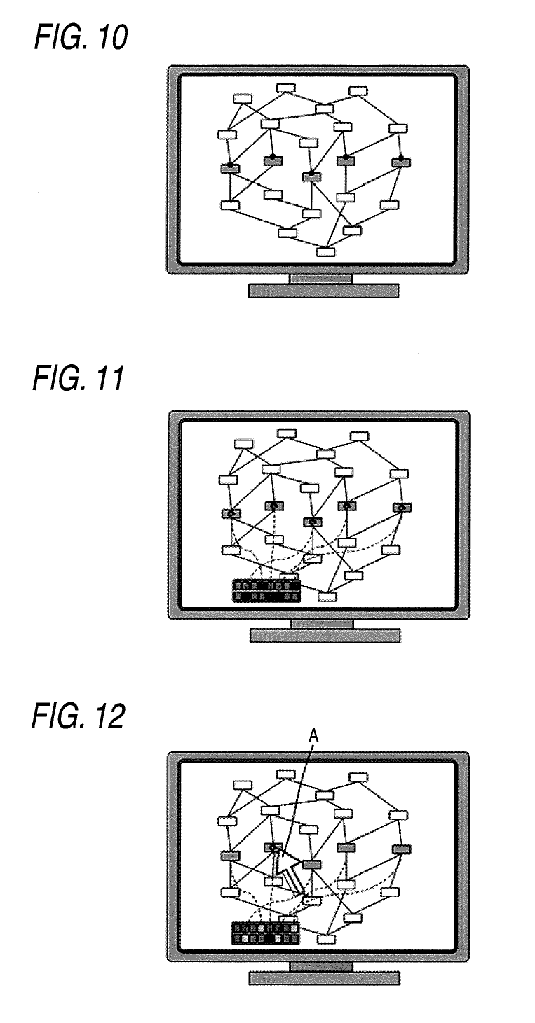

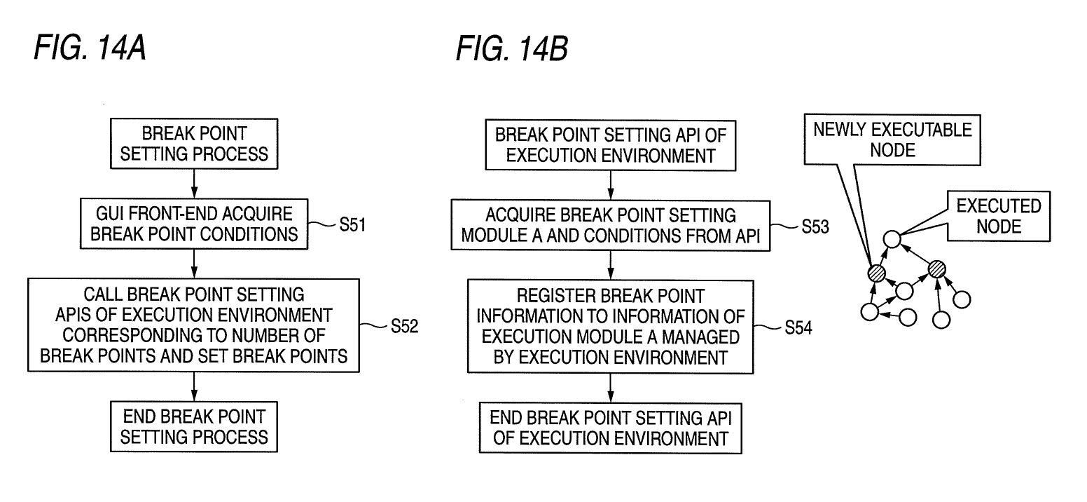

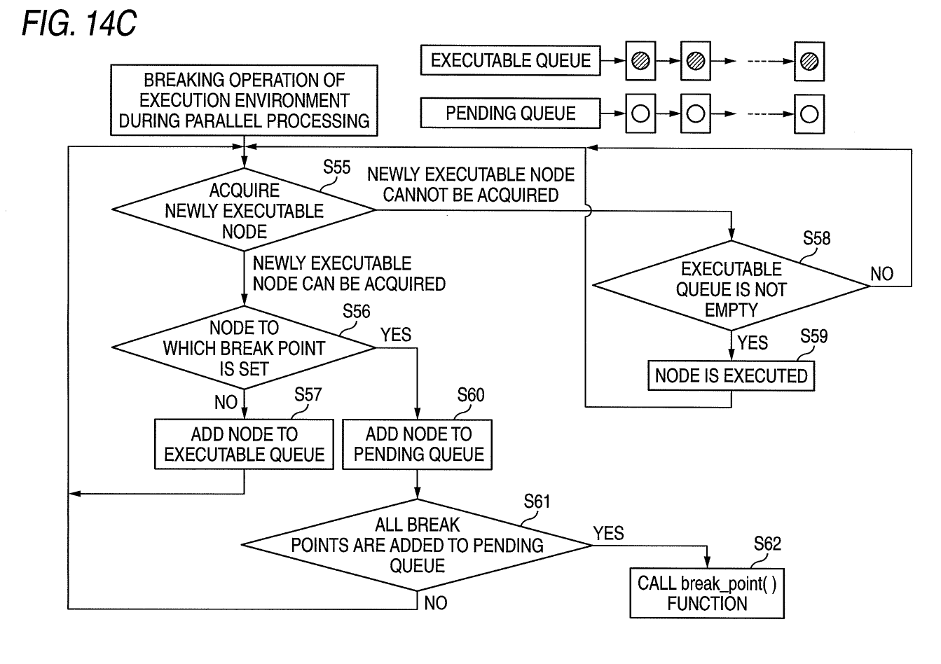

When the setting of the break points is completed, the GUI tool controls the debugger to resume the execution of the program, thereby starting to control the operation of the execution environment. As shown in FIG. 14, when registering an executable task to an executable queue, the execution environment checks whether the breakpoints are set. When the breakpoints are set, the execution environment registers the executable task to a pending queue, without registering it to the executable queue. When all the tasks having the break points set thereto are registered to the pending queue, the execution environment calls a break_point function and executes a break command set to the entry of the function to control the debugger (FIG. 10).

In the process of setting the break points shown in section (a) of FIG. 14, a GUI front-end acquires break point conditions (Step S51), and break point setting APIs of the execution environment that correspond to the number of break points are called to set the break points (Step S52). In the break point setting APIs of the execution environment shown in section (b) of FIG. 14, the API acquires a break point setting module A and conditions (Step S53), and registers break point information to the information of the execution module A managed by the execution environment (Step S54).

In a breaking operation of the execution environment during parallel processing shown in section (c) of FIG. 14, first, it is determined whether to acquire a new executable node (Step S55). If it is determined that it is possible to acquire the node, the process proceeds to the next Step S56. On the other hand, if it is determined that it is unable to acquire the node, the process proceeds to Step S58. In Step S56, it is determined whether the node acquired in Step S55 has break points set thereto. If the determination result is ‘no’, the process proceeds to the next Step S57. On the other hand, if the determination result is ‘yes’ the process proceeds to Step S60. In Step S57, the node is added to the executable queue and the process returns to Step S55.

It is determined in Step S58 whether the executable queue is empty. If it is determined that the executable queue is empty, the process returns to Step S55. If it is determined in Step S58 that the executable queue is not empty, the process proceeds to Step S59. When the node is executed, a core other than the processor core performing the node returns to Step S55 in the multi-core (processor) environment, as described in the runtime operation shown in FIG. 8. In Step S60, the node is added to the pending queue, and the process proceeds to the next Step 61 to determine whether all the breakpoints are added to the pending queue. If the determination result is ‘yes’, the process proceeds to Step S62. If the determination result is ‘no’, the process returns to Step S55.

When the user pushes a parallel step button, the GUI tool calls the API of the parallel execution environment and sets the break point to the next task to be executed, which is adjacent to the current task having the break point set thereto. In addition, the GUI tool transmits information indicating that the current mode is the parallel step mode to the execution environment and continuously executes the program. Since the current mode is the parallel step mode, the execution environment returned from the break_point function dequeues all the tasks from the pending queue and enqueues the tasks to the executable queue. Then, the execution environment resumes execution on the debugger. In this way, it is possible to start the execution of all the tasks to which the breakpoints are set at the beginning substantially at the same time (FIG. 11).

FIG. 12 is a diagram illustrating an operation of designating a specific task with an arrow A and performing a sequential step. In this case, unlike the parallel step, only a designated task is moved from the pending queue to the executable queue.

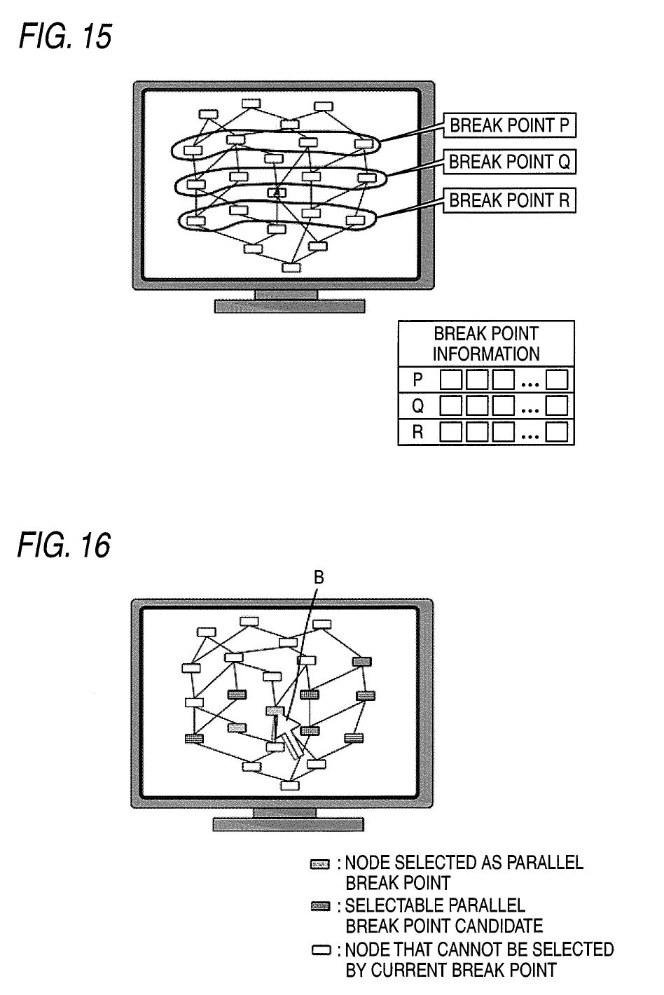

FIG. 15 is a diagram illustrating a method of managing the break points. The GUI tool and the parallel execution environment have break point information (task ID set) for managing a plurality of groups of break points. When setting the parallel break points, the GUI tool checks whether there is a conflict among a plurality of groups of break points. When there is a conflict among a plurality of groups of break points, the GUI tool outputs a message indicating that the setting of the break points is unavailable and does not receive a setting instruction.

If the user tries to set the break point R to include a node A in a situation where there is no conflict among a plurality of groups of break points, such as in a case where the breakpoints P and Q are set as shown in FIG. 15, then, the node A to be included in the break point R would not have a path from any of the nodes included in the break point Q. In this case, the node A may be reached without the process being stopped at the break point Q. Accordingly, the GUI tool notifies the user if the user tries to set the break point to include a node having a path originating from a node not included in the previous break point. As such, when the sequence relation between the break point sets is not clear, it is possible to make the debugging operator understand the order relation between all the parallel operations of the program by visually displaying the sequence relation between the nodes included in the break point sets.

FIG. 16 is a diagram illustrating an example of the display of a screen for supporting the selection of a parallel break point. In this case, unlike FIG. 9, FIG. 16 shows a GUI operation when the parallel breakpoints are selected one by one. The selected node is highlighted (hatched), the preceding node and the subsequent node in the selected node group are represented in an off-color, and a parallel break point candidate is highlighted (represented in a lattice in FIG. 16). The preceding nodes of the node A are a set of nodes on the path to the node A along an arrow B, and the subsequent nodes of the node A are a set of nodes on the path from the node A along the arrow B. As such, when the parallel break point is designated, the node candidates are displayed such that the user can easily know them. Therefore, the user can easily recognize the nodes that can be operated in parallel (that is, the parallel break points).

According to this embodiment, it is possible to significantly improve the debugging efficiency of a parallel program.

This embodiment provides a method of efficiently setting a plurality of break points for a parallel program that is executed by multiple threads. In addition, in the execution of a program to be debugged, it is possible to interrupt the execution of the program at a plurality of break points at the same time. It is also possible to simultaneously resume the execution of a plurality of threads that stops at the break points. Therefore, it is easy to examine the program when a plurality of modules is operated at the same time. It is possible to executes stepwise executes on only a target point among a plurality of threads stopped at the break points while interrupting the execution of points other than the target point. Therefore, it is possible to improve the debugging efficiency of a parallel program. The main points of the embodiment are as follows.

(1) The GUI is used to effectively set the break points of a parallel program.

(2) It is possible to simultaneously stop a plurality of threads under a runtime library at a plurality of set break points.

(3) It is possible to simultaneously resume the execution of the threads that are stopped at a plurality of designated break points.

(4) A unit is provided which specifies a desired module to be executed from the GUI screen and executes only the specified module.

(5) A plurality of groups of break points is managed to support the setting of the break points by the GUI.

The invention is not limited to the above-described embodiment, but various modifications and changes of the invention can be made without departing from the scope and spirit of the invention. For example, in the above-described embodiment, specific visual display is described, but other visual display methods may be executed by substantially the same operation. Any modification of the invention can be made as long as the same operation is executed on the debugger.

Although the embodiment according to the present invention has been described above, the present invention is not limited to the above-mentioned embodiments but can be variously modified. Constituent components disclosed in the aforementioned embodiment may be combined suitably to form various modifications. For example, some of all constituent components disclosed in the embodiment may be removed, replaced, or may be appropriately combined with other components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A debugger comprising:
a plurality of processor cores; and
a scheduler configured to control an allocation of a plurality of basic modules to the processor cores based on an execution rule for enabling parallel execution of a program that is divided into the basic modules that are executable asynchronously with one another, the program being defined with the execution rule of the basic modules for executing the basic modules in time series,
wherein the scheduler comprises a break point setting module configured to set a group of break points that are designated through a graphical user interface.

2. The debugger of claim 1 further comprising:
a retaining module configured to retain information related to the break points.

3. The debugger of claim 1,
wherein the scheduler is configured to operate so as to simultaneously stop a plurality of threads at the break points being set.

4. The debugger of claim 1,
wherein the scheduler is configured to operate so as to simultaneously resume the execution of a plurality of threads that is stopped at the break points being designated.

5. The debugger of claim 1,
wherein the scheduler is configured to operate so as to perform one of the basic modules designated through the graphical user interface exclusively from the other basic modules.

6. The debugger of claim 1,
wherein the scheduler is configured to manage a plurality of groups of the designated break points and to notify conflict between the plurality of groups of the break points or the sequence relation between nodes related to the plurality of break points to a user.

7. A computer readable medium containing a program that causes a computer to perform a series of procedures,
wherein the computer comprises:
a plurality of processor cores; and
a scheduler configured to control an allocation of a plurality of basic modules to the processor cores based on an execution rule for enabling parallel execution of a program that is divided into the basic modules that are executable asynchronously with one another, the program being defined with the execution rule of the basic modules for executing the basic modules in time series, and
wherein the procedures comprises the scheduler to operate as a break point setting module configured to set a group of break points that are designated through a graphical user interface.
